(19) United States
(12) Patent Application Publication
(10) Pub. No.: US 2025/0187057 A1
(43) Pub. Date: Jun. 12, 2025

(54) RAPID LEACHING AND DEWATERING TECHNOLOGY (RLDT) FOR EX-SITU REMEDIATION OF PER- AND POLYFLUOROALKYL SUBSTANCES (PFAS) AND OTHER CONTAMINANTS IN SOIL

(71) Applicants: Troy Wade Emery, Madison, ME (US); Anthony Dean Ahmed, Noblesville, IN (US); Bryan Joseph Massa, Plymouth, MA (US)

(72) Inventors: Troy Wade Emery, Madison, ME (US); Anthony Dean Ahmed, Noblesville, IN (US); Bryan Joseph Massa, Plymouth, MA (US)

(21) Appl. No.: 18/976,947

(22) Filed: Dec. 11, 2024

Related U.S. Application Data
(60) Provisional application No. 63/608,515, filed on Dec. 11, 2023.

(51) Int. Cl. B09C 1/02; B09C 1/08

(52) U.S. Cl. CPC B09C 1/02; B09C 1/085

(57) ABSTRACT

The invention provides a rapid leaching and dewatering system for the remediation of PFAS-contaminated solid matrix material (e.g., soil, sediment, and/or sludge material) for the removal of PFAS compounds, and other contaminants, therefrom. The system mobilizes contaminants from a solid state (soil/sediment/sludge) to a liquid state resulting in a clean solid material.

### CROSS-REFERENCE TO RELATED APPLICATIONS

This application claims priority to, and the benefit of, U.S. Provisional Application No. 63/608,515, filed on Dec. 11, 2023, the content of which is incorporated by reference herein in its entirety.

### TECHNICAL FIELD

The present disclosure relates generally to environmental remediation, and, more particularly, to a uniquely constructed system for providing rapid leaching and dewatering for ex-situ removal of per- and polyfluoroalkyl substances (PFAS) and other contaminants from soil.

### BACKGROUND

Per- and polyfluoroalkyl substances (PFAS) consists of a group of individual chemicals that are used in various industrial and commercial products. High resistance to heat, water, and oil—are some of the noteworthy characteristics that make PFAS extremely useful for many industrial applications and consumer products ranging from non-stick cookware to stain-resistant fabrics. However, the widespread usage of PFAS has led to significant impacts on environmental media such as soil, sediment, surface water, and groundwater.

Aqueous film forming foam (AFFF) has emerged as one of several significant sources of PFAS found in environmental media throughout the world. AFFF was originally developed by the U.S. Naval Research Lab in the 1960s to extinguish fuel fires fasters. The widespread use of AFFF containing PFAS has resulted in significant impacts to environmental medial at multiple sites that used AFFF including military installations, airports, bulk fuel storage areas, fire training academies, and other firefighting response areas.

PFAS have very limited reactivity, making them particularly persistent in the environment and bio accumulative in human and animal tissues—and this is especially true for “long-chain” PFAS chemicals, such as perfluoro octane sulfonate (PFOS). These same characteristics that make PFAS so effective in industrial application and other products, make them particularly difficult to remediate.

Reports of environmental and human health impacts of PFAS outlining the widespread human exposure to PFAS through water, food, and air, have exponentially increased in recent times. Lengthy environmental persistence and biological half-lives of some PFAS have led to measurable PFAS in the blood of nearly the entire population in developed countries, with health effects reported globally.

PFAS is primarily released into the environment through two major sources-point and nonpoint sources. Point sources are discrete and stationary, such as any industrial or manufacturing facilities, firefighting training sites, wastewater treatment plants (WWTPs), and landfills. Nonpoint sources are diffused sources of unknown origin and location and often involve the release from multiple sources, such as through atmospheric, biological and chemical breakdown of precursor compounds into stable PFAS, surface runoff, precipitation, or consumer product breakdown.

PFAS has been widely detected in surface water, groundwater, and soil at locations in the US and around the world. Growing toxicology research on this contaminant class has albeit led to increased societal and regulatory awareness but because PFAS have one of the strongest chemical bonds known (the carbon-fluorine bond), it makes them extremely resistant to degradation in the environment and challenging to remediate.

Current remediation options for soil contaminants such as PFAS are limited and costly. For example, traditional soil washing utilizes mechanical mixing, separation, and spray water to “rinse” contaminants from the soil. The process results in sludge as a biproduct with only a portion of clean soil remaining. The process is labor and power intensive and inefficient. It requires significant site preparation for wash plant construction and results in the need to export contaminated sludge and import clean backfill. Excavation and disposal of PFAS impacted soil at a Subtitle C landfill is also extremely costly and will remove precious landfill space for future use.

Furthermore, current PFAS treatment technologies for treating contaminated soil can be ineffective. For example, current PFAS treatments generally aim to remediate PFAS in a liquid state by targeting their physical and chemical properties. Typical treatment methods for PFAS in a liquid state include foam fractionation, granulated activated carbon (GAC), ion exchange resins, sonication, and super critical water oxidation. Since PFAS are uniquely persistent, existing water treatment technologies including air sparging and enhanced aerobic bioremediation have shown limited success in remediating PFAS. The complexity of PFAS treatment becomes even greater in contaminated soil. This is due to their strong carbon and fluorine bonds, which makes PFAS treatment methods on contaminated soil such as thermal treatment, chemical oxidation, and air stripping, challenging.

### SUMMARY

The invention of the present disclosure addresses the limited and extremely cost prohibitive remediation techniques for solids (soil/sediment/sludge) by providing a cost-effective and sustainable approach for the removal of contaminants in a solid state (soil, sediment, or sludge), including but not limited to, removal of PFAS, petroleum hydrocarbons and solvents. More specifically, the invention is directed to a rapid leaching and dewatering system for the remediation of PFAS-contaminated soil for the removal of PFAS compounds, and other contaminants, therefrom. By effectively reducing and/or completely eliminating the concentration of PFAS and other contaminants from soil, the risk of such contaminants leaching into groundwater or surface water is reduced/eliminated. Accordingly, the system of the present invention improves land, sediment, surface water, and groundwater quality.

The system is configured to mobilize a contaminant from a solid state (soil, sediment, or sludge) to a liquid state. More specifically, the system comprises a containment pond and a filtration system, which allows a solid to be fully saturated with water and then rapidly dewatered. The containment pond may generally be constructed from geomembrane and geosynthetic clay liners. The filtration system may generally be constructed from multiple layers of geocomposite materials imbedded with stone to allow liquid to pass through while retaining sand and other non-liquid particles.

As such, the system (and associated remediation processes) of the present invention is different than traditional soil washing techniques. For example, in contrast to mechanical mixing and rinsing, the present invention allows for full soil saturation to occur within the containment pond. The use of full saturation allows contaminants to partition from a solid state into the liquid phase. Once the contaminants have been removed from the solid, the solid is rapidly dewatered, dried, and placed back into the excavation, reused or otherwise disposed of. The liquid (i.e., leachate) can then be conveyed through conduits (e.g., piping or the like) and transported to a watertight holding or collection pond that is similarly constructed to the containment pond. The leachate is then pumped through a wastewater treatment system to thereby remove PFAS compounds and/or other contaminants for future destruction or disposal.

This partitioning will help reduce the quantity of contaminated solids sent to landfills which in turn will reduce the number of trucks on the road and maintain landfill compacity for other essential uses. Additionally, contaminant source removals from solids have an immediate and proportional effect on improving groundwater and surface water quality. By utilizing the unique physical and chemical properties of PFAS (and various other contaminants such as petroleum hydrocarbons and solvents), the system will allow PFAS (and other contaminants) to be removed from the solid matrix utilizing a combination of liquid saturation with additives as needed (pH adjustment, surfactants, bacterial additives, remedial additives, etc.).

Accordingly, the system of the present invention provides numerous advantages and benefits over current remediation process. In particular, the system of the present invention provides a cost-effective alternative to traditional soil PFAS remediation methods. The system of the present invention is sustainable, in that, once installed, the assembly becomes a reusable asset, similar to a building, providing long-term value. The system is reusable and can be used to treat future PFAS impacted soil in the event of an emergency requirement the application of AFFF containing PFAS. The system is highly scalable, in that it can be designed and adapted to projects of any size, from small-scale cleanups to large-scale remediation efforts (i.e., <100 cubic yards or >1,000 cubic yards). Furthermore, the design of the system allows for seamless integration of future PFAS liquid treatment technologies, including sonication and other innovations under development.

### BRIEF DESCRIPTION OF THE DRAWINGS

Features and advantages of the claimed subject matter will be apparent from the following detailed description of embodiments consistent therewith, which description should be considered with reference to the accompanying drawings.

FIG. 1 is a flow diagram illustrating an exemplary remediation process consistent with the present disclosure.

FIG. 2 is a plan view of an exemplary rapid leaching and dewatering system for the remediation of PFAS-contaminated soil consistent with the present disclosure.

FIGS. 3A and 3B are sectional views of the system of claim FIG. 2, including a sectional view of the containment pond (FIG. 3A) and a sectional view of the collection pond (FIG. 3B).

FIGS. 4A and 4B are enlarged sectional views of the double layer pond liner illustrating the general arrangement (FIG. 4A) and an overlapping portion (FIG. 4B).

FIGS. 5A and 5B are enlarged sectional views of the drainage system (WIP-DRAIN) illustrating the general arrangement (FIG. 5A) and an overlapping portion (FIG. 5B).

FIG. 6 is an enlarged sectional view illustrating the interface of the double layer pond liner and HDPE pipe boot.

FIG. 7 is a schematic illustrating an exemplary bench test setup including the use of an HDPE reactor cell for performing a bench scale study of the remediation processes consistent with the present disclosure.

FIG. 8 is an image of an exemplary bench test setup for performing a bench scale study of the remediation processes consistent with the present disclosure.

For a thorough understanding of the present disclosure, reference should be made to the following detailed description, including the appended claims, in connection with the above-described drawings. Although the present disclosure is described in connection with exemplary embodiments, the disclosure is not intended to be limited to the specific forms set forth herein. It is understood that various omissions and substitutions of equivalents are contemplated as circumstances may suggest or render expedient.

### DETAILED DESCRIPTION

By way of overview, the objective of this invention is to provide a cost-effective alternative for the general remediation of contaminants in a solid state (soil, sediment, or sludge), including but not limited to PFAS, petroleum hydrocarbons and solvents. The remediation of PFAS and other contaminants will allow for a cost effective and sustainable approach to remediate soil, sediment or sludge. The invention proposes to remediate contaminants in a solid state to improve land, sediment, surface water, and groundwater quality.

As previously described herein, traditional soil remediation techniques, such as thermal desorption, soil washing, incineration, in-situ chemical oxidation/biological degradation, and landfill disposal can be inefficient, costly and time consuming. The use of the rapid leaching and dewatering technology (RLDT) of the present invention will allow for a cost effective and sustainable approach to remediate soil, sediment, or sludge, as described in greater detail herein.

The proposed remediation treatment technology of the RLDT invention will mobilize a contaminant from a solid state (soil, sediment, or sludge) to a liquid state. This partitioning will help reduce the quantity of contaminated solids sent to landfills which in turn will reduce the number of trucks on the road and maintain landfill compacity for other essential uses. Additionally, contaminant source removals from solids have an immediate and proportional effect on improving groundwater and surface water quality.

Current remediation options for soil contaminants such as PFAS are limited and costly. For example, traditional soil washing utilizes mechanical mixing, separation, and spray water to “rinse” contaminants from the soil. The process results in sludge as a biproduct with only a portion of clean soil remaining. The process is labor and power intensive and inefficient. It requires significant site preparation for wash plant construction and results in the need to export contaminated sludge and import clean backfill. Excavation and disposal of PFAS impacted soil at a Subtitle C landfill is also extremely costly and will remove precious landfill space for future use.

The system and processes of the present invention are different than traditional soil washing techniques. Instead of mechanical mixing and rinsing, the present invention allows for soil saturation to occur within a containment cell. Full saturation does not occur in soil washing. Full saturation allows contaminants to partition from a solid state into the liquid phase. Once the contaminants have been removed from the solid, the solid is rapidly dewatered, dried, and placed back into the excavation, reused or otherwise disposed of. By utilizing the unique physical and chemical properties of PFAS (and various other contaminants such as petroleum hydrocarbons and solvents), the invention will allow PFAS (and other contaminants) to be removed from the solid matrix utilizing a combination of liquid saturation with additives as needed (pH adjustment, surfactants, bacterial additives, remedial additives, etc.).

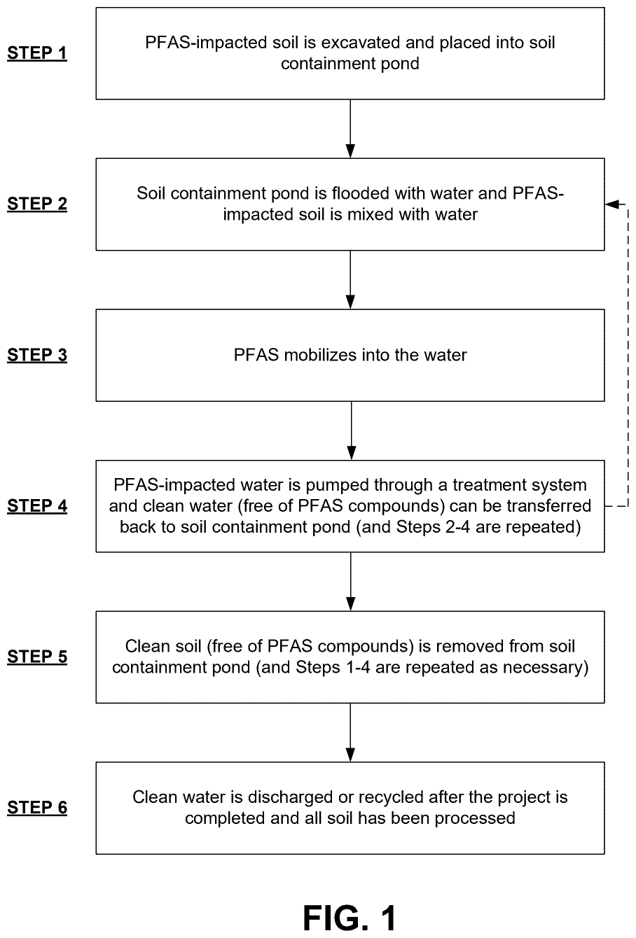

FIG. 1 is a flow diagram illustrating an exemplary remediation process consistent with the present disclosure. As an initial step in the process carried out by the system of the present invention, contaminated (or potentially contaminated) soil is placed into a containment pond (Step 1). The containment pond is then flooded with water to allow the soil to become sufficiently mixed with the water (Step 2). At this point, full soil saturation is allowed to occur in the containment pond. The use of full saturation allows contaminants (i.e., PFAS compounds) to partition from a solid state into the liquid phase (Step 3). PFAS-impacted water is subsequently pumped through a treatment system (for removable of PFAS compounds therefrom) (Step 4). It should be noted that clean water (free of PFAS compounds) can be transferred back to the containment pond. Once the contaminants have been removed from the solid, the solid is rapidly dewatered, dried, and placed back into the excavation, reused or otherwise disposed of (Step 5). Clean water is either discharged and/or recycled after the project is completed and all soil has been processed (Step 6).

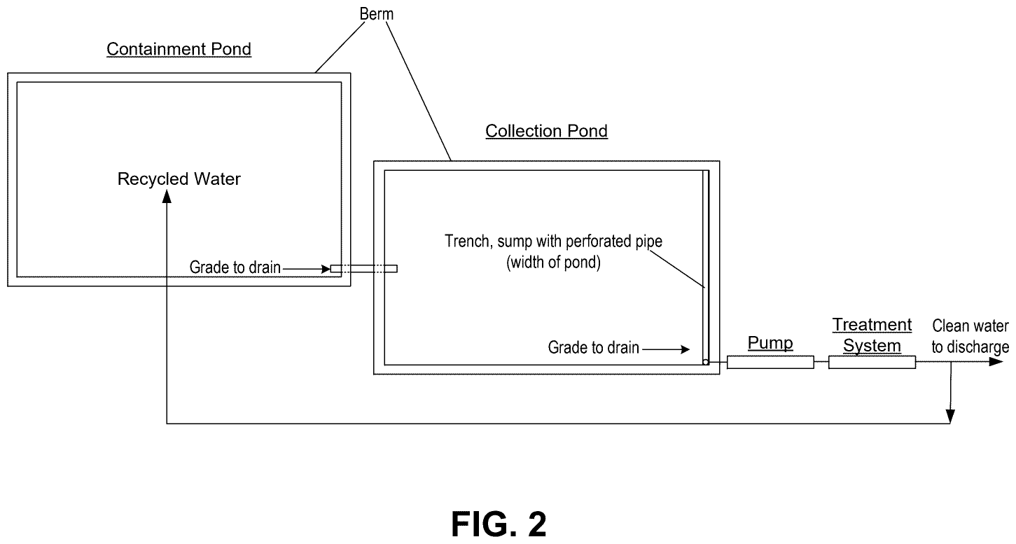

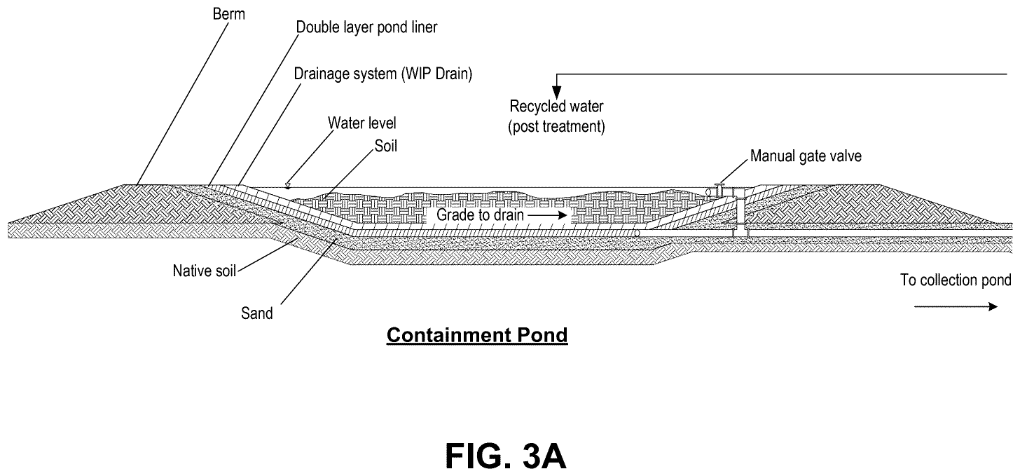

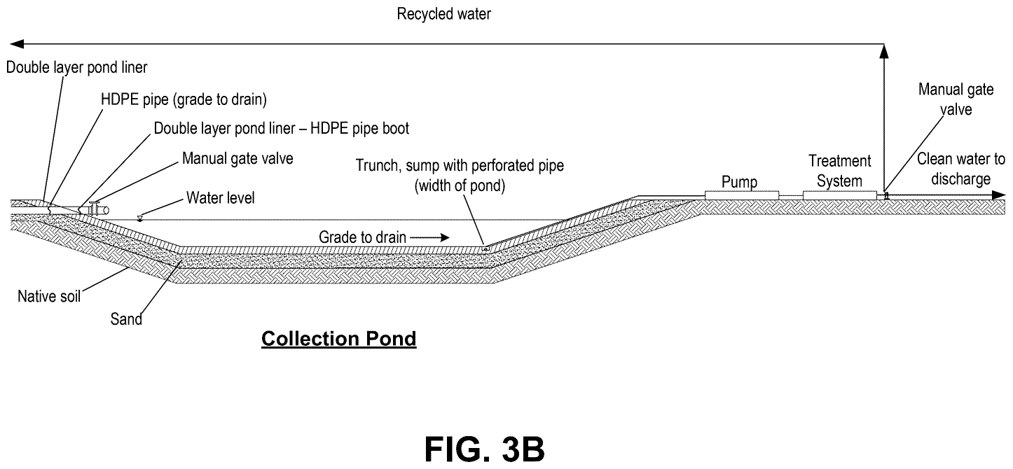

FIG. 2 is a plan view of an exemplary rapid leaching and dewatering system for the remediation of PFAS-contaminated soil consistent with the present disclosure. FIGS. 3A and 3B are sectional views of the system of claim FIG. 2, including a sectional view of the containment pond (FIG. 3A) and a sectional view of the collection pond (FIG. 3B).

As shown, the overall setup generally consists of a containment pond, a uniquely designed drainage layer located within the containment pond that allows a solid to be fully saturated with water and then rapidly dewatered after each rinse cycle, and a collection pond. In particular, the entire solid remediation process takes place within a double-lined and bermed containment pond, similar to a landfill cell. A geosynthetic clay liner located between the geomembrane layers provides an extra factor of safety. The containment pond is watertight and can hold solids and liquid.

The drainage layer/system is constructed from multiple layers of geocomposite materials imbedded with stone to allow liquid to pass through while retaining sand and other non-liquid particles. In particular, the drainage layer/system may be similarly constructed as the drainage or filtration systems described in U.S. Pat. No. 10,634,427 (RTD Enterprises), the content of which is incorporated by reference herein in its entirety. For example, the system of the present invention may utilize the WIP-DRAIN passive draining apparatus offered by R.T.D. Enterprises.

Once the solid is saturated, the highly soluble PFAS contaminates within the solid matrix are partitioned into a liquid phase. The containment pond is connected to a similarly constructed collecting pond through a liquid conveyance system (i.e., piping) that is booted to the geomembrane layers. The collection pond receives leachate from the containment pond, wherein the leachate can generally include the PFAS compounds that have mobilized into the water.

Accordingly, once in a liquid phase, the PFAS analytes can be easily removed and consolidated through a wastewater treatment process. In particular, the leachate can be pumped from the collection pond into a wastewater treatment system where contaminants are removed.

The treated wastewater can be recycled back into the containment pond and the process repeated until the desired contaminant removal has been achieved, or discharged.

The solid may then be re-saturated with the treated water within the containment pond as necessary until the desired PFAS removal limits have been obtained (i.e., EPA Regional Screening Levels).

Some general examples of wastewater treatment technologies that that can be easily incorporated into the RLDT treatment process resulting in PFAS destruction or volume consolation for disposal include:
1. The wastewater is pumped through vessels containing GAC. The PFAS is sorbed onto the GAC and then it is sent to either:
   a. A permitted regeneration facility for thermal destruction (non-incineration process) of PFAS. After regeneration, the GAC can be reused for PFAS treatment.
   b. A solvent washing and recovery system to partition the PFAS from the GAC into the solvent. The solvent is then distilled and concentrated. The concentrate is then destroyed using super critical oxidation resulting in PFAS destruction. After the solvent washing is complete, the GAC is regenerated and can be reused for PFAS treatment.
   c. A hazardous waste landfill for disposal as a spent remediation waste.
   d. A hazardous waste incinerator.
2. The wastewater is concentrated through foam fractionation and then the PFAS is destroyed through electrochemical oxidation.
3. The wastewater is concentrated through foam fractionation and then the PFAS is destroyed using super critical water oxidation.
4. The wastewater is concentrated through foam fractionation and then the PFAS disposed of at a permitted hazardous waste injection well.

Once the appropriate number of rinses have been completed to meet the applicable PFAS standards, the soil is left to dry for 24 hours. After 24-hours, the soil will reach an appropriate moisture content (i.e., non-saturated and can be removed for reuse or disposal). Once dry, amendments can be added for stabilization, if necessary.

### Bench Scale Study

Considering that PFAS is a new and emerging containment, the first two benchtop studies focused on the effectiveness of RLDT as a remedial strategy for PFAS impacted soil using three to four rinse cycles only. These two studies documented average total PFAS (sum of all reported analytes using EPA Method 1633) removal in soil ranging from 89 to 93 percent. The technology removed 94 to 100 percent of the five PFAS analytes currently regulated by the Environmental Protection Agency (EPA). Additional rise cycles can be incorporated into the technology to achieve additional PFAS removal to meet site specific remedial goals. Although the bench studies focused on PFAS, this technology will work on multiple contaminants that can be partitioned from a solid state into a liquid state.

The benchtop study successfully demonstrates the capability of RLDT to transfer (partition) PFAS from soil to a liquid state. Once liquefied, the PFAS can be destroyed using sorption with high temperature destruction and regeneration, sonication, or other innovative destructive methods.

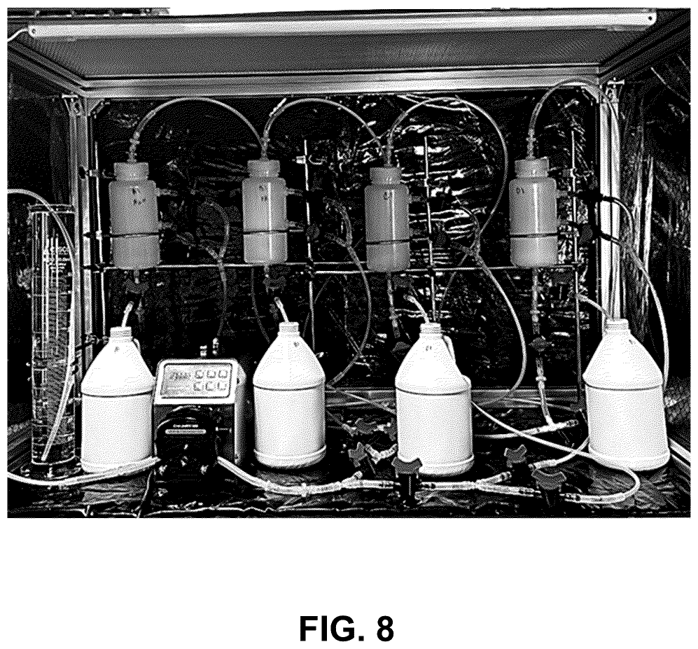

The bench scale study is performed using soil, sediment or sludge obtained from the specific site where RLDT is to be utilized. The bench scale study will determine the number of rinses required to remove contaminants to the desired levels and if pH adjustment or added surfactants/remedial additives will aid in mobilizing the contaminants. The study will utilize at least four reactor vessels constructed from HPDE that mimic the RLDT containment cell as shown in the photograph of FIG. 8.

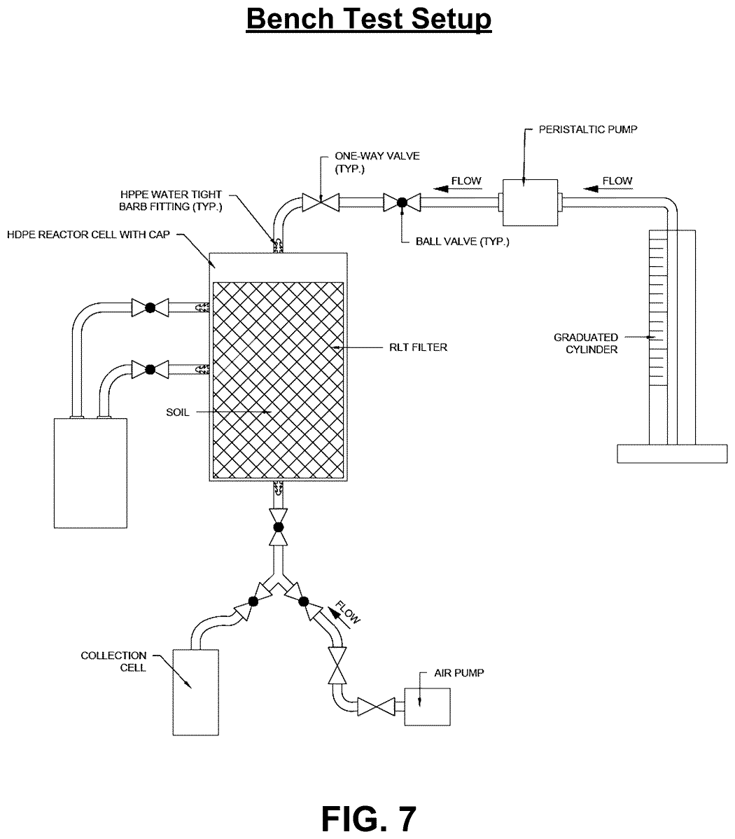

Each of the HDPE reactor cells in the photograph (top rack) is equipped with a specialty filter cell that represents the drainage layer (WIP-DRAIN) located within the containment pond. The valves depicted in the photograph allow each HDPE reactor cell to operate independently, using a measured volume of water from the graduated cylinder (left side of photo). The water is pumped from the graduated cylinder at a consistent flow rate through a peristaltic pump (center of photograph) into the desired HDPE reactor cell that contains a sample of the material proposed for remediation. The leachate from each rinse cycle (in general, 1 to 2 liters) is then collected and analyzed by a laboratory to determine the amount of contaminant removed during each rinse cycle. The solid sample from within the HDPE reactor cell is removed after the required number of rinse cycles and also analyzed at a lab to determine the remaining contaminant levels after a given number of rinse cycles have been completed. A schematic of an HDPE reactor cell is shown in FIG. 7, and a general description of the potential tests completed during a typical bench scale study is described below:

Test 1: Reactor vessel is flooded with water at an approximate neutral pH, aerated from the bottom for five minutes before rapidly draining and collecting the leachate. Anti-foaming agents may be utilized to control foaming. Draining will first occur from the top of the water column to remove and consolidate non-aqueous phase liquid. Next, the remaining liquid will be rapidly dewatered through the bottom drain and collected. The rinse cycle will be repeated at least three more times. A solid sample (soil, sediment, or sludge) from the reactor vessel will be collected after the final rinse cycle is completed. One solid sample and at least four liquid samples (one from each rinse cycle) will be collected for laboratory analysis. The laboratory results will be used to determine the concentration of contaminant removed during each rinse cycle. It will also be used to determine if additional rinse cycles beyond four are needed to achieve the desired contaminant removal.
Test 2: Reactor vessel will be flooded with acid adjusted water (pH less than 6), aerated from the bottom for five minutes before rapidly draining and collecting the leachate. Anti-foaming agents may be utilized to control foaming. Draining will first occur from the top of the water column to remove and consolidate non-aqueous phase liquid. Next, the remaining liquid will be rapidly dewatered through the bottom drain and collected. The rinse cycle will be repeated at least three more times. A solid sample (soil, sediment, or sludge) from the reactor vessel will be collected after the final rinse cycle is completed. One solid sample and at least four liquid samples (one from each rinse cycle) will be collected for laboratory analysis. The laboratory results will be used to determine the concentration of contaminant removed during each rinse cycle. It will also be used to determine if additional rinse cycles beyond four are needed to achieve the desired contaminant removal.
Test 3: Reactor vessel will be flooded with basic adjusted water (pH greater than 7), aerated from the bottom for five minutes before rapidly draining and collecting the leachate. Anti-foaming agents may be utilized to control foaming. Draining will first occur from the top of the water column to remove and consolidate non-aqueous phase liquid. Next, the remaining liquid will be rapidly dewatered through the bottom drain and collected. The rinse cycle will be repeated at least three more times. A solid sample (soil, sediment, or sludge) from the reactor vessel will be collected after the final rinse cycle is completed. One solid sample and at least four liquid samples (one from each rinse cycle) will be collected for laboratory analysis. The laboratory results will be used to determine the concentration of contaminant removed during each rinse cycle. It will also be used to determine if additional rinse cycles beyond four are needed to achieve the desired contaminant removal.
Test 4: Reactor vessel will be flooded with water/surfactant or a remedial additive at a specific pH (neutral for a surfactant or adjusted to a specific pH necessary for a remedial additive), aerated from the bottom for five minutes before rapidly draining and collecting the leachate. Anti-foaming agents may be utilized to control foaming. Draining will first occur from the top of the water column to remove and consolidate non-aqueous phase liquid. Next, the remaining liquid will be rapidly dewatered through the bottom drain and collected. The rinse cycle will be repeated at least three more times. A solid sample (soil, sediment, or sludge) from the reactor vessel will be collected after the final rinse cycle is completed. One solid sample and at least four liquid samples (one from each rinse cycle) will be collected for laboratory analysis. The laboratory results will be used to determine the concentration of contaminant removed during each rinse cycle. It will also be used to determine if additional rinse cycles beyond four are needed to achieve the desired contaminant removal.

Additional testing beyond what is described above may be necessary and could include using various pH, increasing or decreasing the number of rinses, varying pH between rinses, adding surfactants or remedial additives.

### Pilot/Field Test Study

Following the bench scale/concept study, a pilot/filed test study will be carried out prior to scaling up. The proposed activities in the field test study is divided into four parts: (1) Feasibility analysis, (2) Engineering design, (3) Construction of a single reactor cell, and (4) Execution of a field test study. The pilot study will be implemented using the optimal rinse cycles determined during the bench scale/concept study described above.

### Construction of RLDT System

Upon successfully implementation of a pilot/field test, a full scale RLDT system consistent with the details provided in FIGS. 2, 3A-3B, 4A-4B, 5A-5B, and 6 can be designed and constructed. In general, full scale RLDT will be sequenced as follows:
1. Complete site survey and prepare civil/environmental engineering design plans to construct a site specific RLDT.
2. Construct the RLDT containment pond.
3. Construct a filtration/drainage system within the containment pond from multiple layers of geocomposite materials imbedded with stone (i.e., utilizing embodiments of the drainage or filtration systems described in U.S. Pat. No. 10,634,427 (RTD Enterprises), such as the WIP-DRAIN passive draining apparatus).
4. Install a large bubble aeriation system within the filtration system to promote mixing and promote non-aqueous phase separation/foam fractionation.
5. Connect the solid containment pond to a lined liquid collection pond.
6. Connect the liquid collection pond to a wastewater treatment system designed by an engineer. The wastewater treatment system may include but is not limited to bag filters, aeriation, pH adjustment, sonolytic destruction, activated carbon, reverse osmosis filtration, resigns, foam fractionation, organoclays, cartridge filtration, and/or supercritical water oxidation.

### RLDT Operation

1. Place contaminated solids into the lined containment pond and flood it with water saturating the solids completely.
2. Aerate the solids and liquids within the containment pond to promote mixing and non-aqueous phase separation.
3. Discontinue aeration and then drain the non-aqueous phase liquid from the top of the containment pond and either hold for concentration in a frac tank, send to the wastewater treatment system, or discharge into the liquid collection pond.
4. Rapidly dewater remaining liquid from containment pond into the liquid collection pond and then pump liquid from the collection pond through the wastewater treatment system.
5. Discharge clean water from the wastewater treatment system back into the containment pond through solid matrix (soil, sediment or sludge) and begin cycle again (items 2 through 5).
6. Once desired treatment level is achieved, temporarily store final rinse in collection pond and allow solid to dry in containment pond before removing it and placing it back into the excavation, reused or otherwise disposed of.
7. Add more contaminated solids into the containment pond and pump water temporarily held in the collection pond through the wastewater system and then discharge the clean water into the containment pond through solid matrix (soil, sediment or sludge) and begin cycle again (items 2 through 6).
8. The system is reusable and is expected to last for years. The water within the system is continuously recycled making this a green technology.

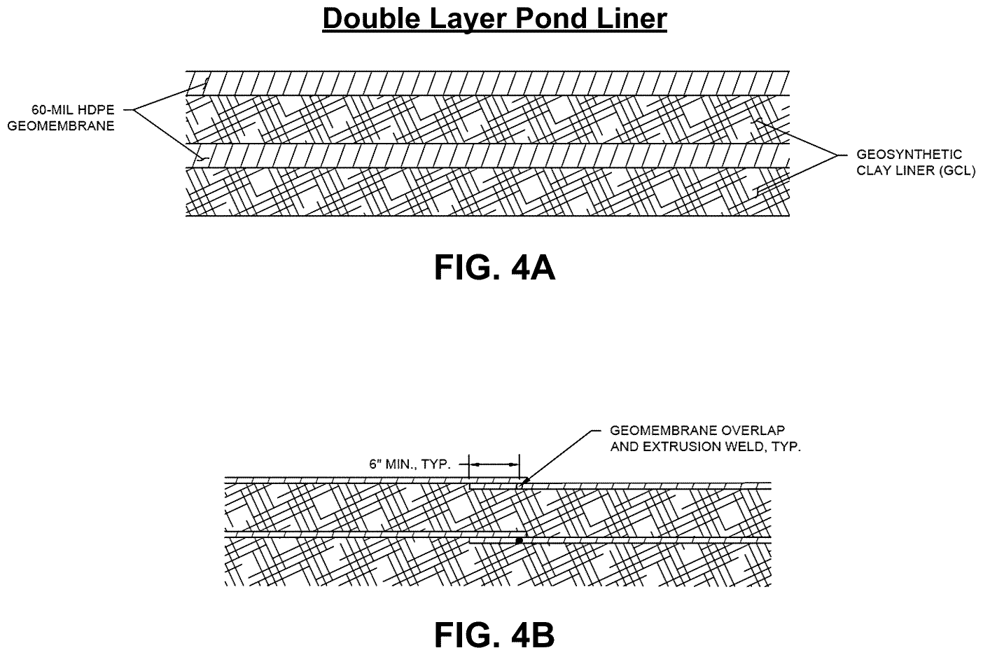

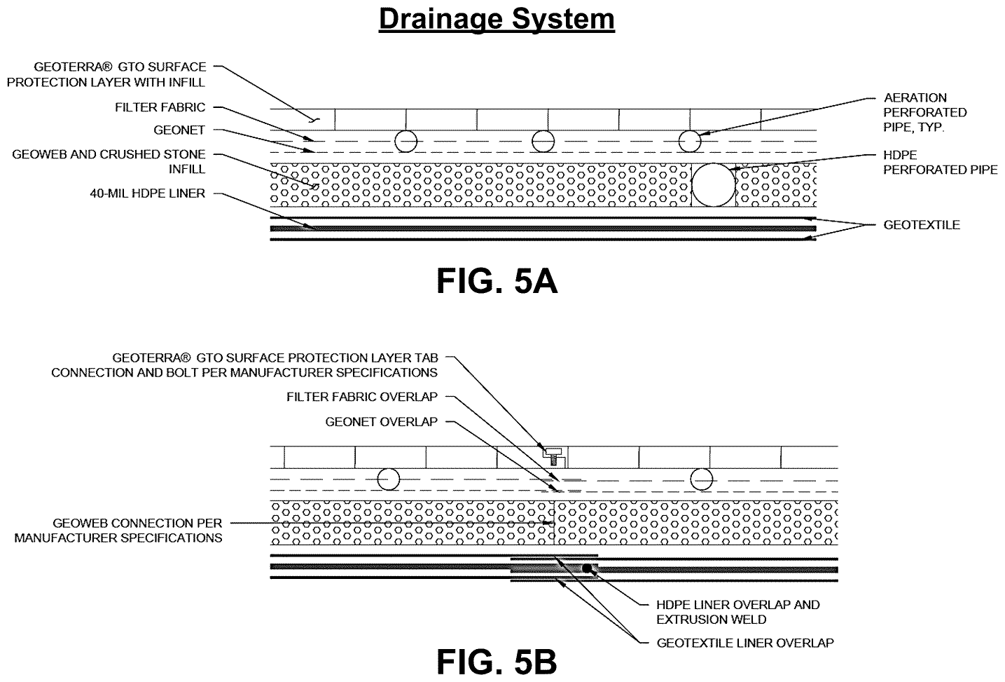

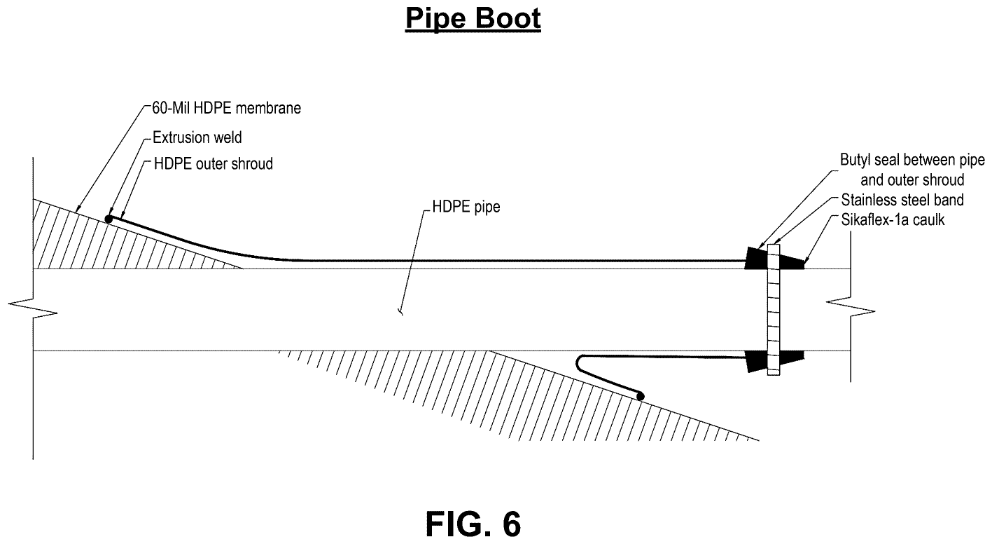

A plan and sectional view of the RLDT system is included as FIGS. 2 and FIGS. 3A-3B, respectively. FIGS. 4A and 4B are enlarged sectional views of the double layer pond liner illustrating the general arrangement (FIG. 4A) and an overlapping portion (FIG. 4B). FIGS. 5A and 5B are enlarged sectional views of the drainage system (WIP-DRAIN) illustrating the general arrangement (FIG. 5A) and an overlapping portion (FIG. 5B) thereof. FIG. 6 is an enlarged sectional view illustrating the interface of the double layer pond liner and HDPE pipe boot.

FIGS. 3A and 3B are sectional views of the system of claim FIG. 2, including a sectional view of the containment pond (FIG. 3A) and a sectional view of the collection pond (FIG. 3B). As shown, construction of a solids collection pond utilizing a primary and secondary liner system made from geomembrane and geosynthetic clay liners. A WIP-DRAIN apparatus is placed within the solids collection pond to allow for 180 degrees of drainage. Drainage occurs from the sides and bottom of the WIP-DRAIN. A drainage conveyance system is located within and above the WIP-DRAIN that is connected to a watertight collection pond consisting of a primary and secondary liner system made from geomembrane and geosynthetic clay liners. Water can be drained from the top or bottom of the collection pond through a conveyance pipe system that is sealed into the primary and secondary liner system. The sealing of the drainage pipe to the liner system is known as a “boot”. The collection pond is sloped to allow for drainage by gravity. A series of gate valves control the flow of water into and out of the collection pond. Water from the drainage pond is conveyed by gravity into the collection pond where it is pumped through a wastewater treatment system. The treated wastewater from the treatment system is then recycled into the collection pond and the process is completed again.

FIGS. 4A and 4B provide detailed view of the double layer pond liner system including the use of geomembrane and geosynthetic clay liner. FIGS. 5A and 5B provide a detailed view of the WIP-DRAIN apparatus including the addition of large bubble aeriation to allow for mixing. FIG. 6 provides a detailed view of the boot used to seal the conveyance piping to the primary and secondary liners.

Accordingly, the system of the present invention provides numerous advantages and benefits over current remediation process. In particular, the system of the present invention provides a cost-effective alternative to traditional soil PFAS remediation methods. The system of the present invention is sustainable, in that, once installed, the assembly becomes a reusable asset, similar to a building, providing long-term value. The system is reusable and can be used to treat future PFAS impacted soil in the event of an emergency requirement the application of AFFF containing PFAS. The system is highly scalable, in that it can be designed and adapted to projects of any size, from small-scale cleanups to large-scale remediation efforts (i.e., <100 cubic yards or >1,000 cubic yards). Furthermore, the design of the system allows for seamless integration of future PFAS liquid treatment technologies, including sonication and other innovations under development.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

1. A rapid leaching and dewatering system for the remediation of a solid matrix containing a contaminant, the system comprising:
a containment pond for receiving a solid matrix material containing one or more contaminants and a volume of liquid sufficient to fully saturate the solid matrix material to thereby mobilize the one or more contaminants from the solid matrix material and into the liquid, the containment pond comprising a watertight liner;
a drainage system within the containment pond and positioned over the watertight liner, the drainage system comprising one or more layers of geocomposite materials imbedded with stone to thereby allow liquid to pass therethrough while retaining non-liquid material, including the solid matrix material; and
a collection pond fluidically coupled to the containment pond via at least one conveyance pipe, the collection pond comprising a watertight liner and configured to receive liquid from the containment pond upon drainage of liquid from the collection pond, the drained liquid comprising leachate containing one or more contaminants partitioned from the solid matrix material and mobilized into the liquid.

2. The system of claim 1, wherein the solid matrix material comprises at least one of soil, sediment, and sludge.

3. The system of claim 1, wherein the liquid comprises water.

4. The system of claim 1, wherein the flow of liquid to the collection pond is gravity-fed.

5. The system of claim 4, wherein the containment pond is positioned at a higher elevation than the collection pond.

6. The system of claim 1, further comprising an aeration assembly positioned at a bottom of the containment pond and configured to aerate the solid matrix material and liquid within the containment pond to promote mixing and non-aqueous phase separation.

7. The system of claim 6, wherein the aeration assembly comprises a plurality of perforated pipe members configured to release a plurality of bubbles to promote aeration.

8. The system of claim 1, wherein the watertight liner of the containment pond comprises a multilayer liner assembly comprising at least one geosynthetic clay liner positioned between two geomembrane layers.

9. The system of claim 8, wherein the multilayer liner assembly comprises a primary liner assembly positioned over a secondary liner assembly.

10. The system of claim 9, wherein each of the primary and secondary liner assemblies comprises a geomembrane liner layer positioned over a geosynthetic clay liner layer.

11. The system of claim 10, wherein the watertight liner of the collection pond comprises a multilayer liner assembly comprising a primary liner assembly positioned over a secondary liner assembly, wherein each of the primary and secondary liner assemblies comprises a geomembrane liner layer positioned over a geosynthetic clay liner layer.

12. The system of claim 11, wherein at least one end of the at least one conveyance pipe is sealed into engagement with the primary and secondary liner assemblies via a boot member.

13. The system of claim 1, further comprising a first pump assembly operably coupled to the collection pond via one or more pipes and configured to pump liquid, including the leachate, out of the collection pond and to undergo subsequent treatment for the removal of one or more contaminants therefrom.

14. The system of claim 13, further comprising a treatment system configured to receive, from the collection pond, and treat the liquid, including the leachate, to thereby entirely remove or sufficiently reduce the concentration of one or more contaminants therefrom.

15. The system of claim 14, wherein the treatment system comprises one or more vessels comprising granular activated carbon (GAC).

16. The system of claim 15, wherein recovered contaminants sorbed onto the GAC is provided to at least one of: 1) a permitted regeneration facility for thermal destruction; 2) a solvent washing and recovery system to partition the contaminants from the GAC into a solvent to be subsequently destroyed; 3) a hazardous waste landfill for disposal; and 4) a hazardous waste incinerator.

17. The system of claim 14, wherein the liquid, including the leachate, is concentrated through foam fractionation.

18. The system of claim 17, wherein recovered contaminants are destroyed by way of at least one of electrochemical oxidation and super critical water oxidation or disposed of at a permitted hazardous waste injection well.

19. The system of claim 13, further comprising a second pump assembly configured to pump treated liquid that has undergone treatment for the removal of contaminants back to the containment pond for subsequent use in saturating the existing solid matrix material within the containment pond and/or additional solid matrix material and/or new solid matrix material placed within the containment pond.

20. The system of claim 1, wherein the one or more contaminants comprises at least one of: per- and polyfluoroalkyl substances (PFAS) compounds; petroleum hydrocarbons; and petroleum solvents.
